(19) United States
(12) Patent Application Publication
(10) Pub. No.: US 2025/0225429 A1
(43) Pub. Date: Jul. 10, 2025

(54) USING MACHINE LEARNING TO DETERMINE DATA QUALITY RULES

(71) Applicant: Capital One Services, LLC, McLean, VA (US)

(72) Inventors: Danrisha YOUNG, Herndon, VA (US); Mohamed SECK, Aubrey, TX (US)

(21) Appl. No.: 18/406,712

(22) Filed: Jan. 8, 2024

(51) Int. Cl. G06N 20/00

(52) U.S. Cl. CPC G06N 20/00

(57) ABSTRACT

In some implementations, an analysis system may receive, from at least one data source, a set of structured data. The analysis system may provide the set of structured data to a machine learning model to receive an indication of a proposed rule. The analysis system may transmit, to an administrator device, a prompt indicating the proposed rule. The analysis system may receive, from the administrator device, an acceptance of the proposed rule in response to the prompt. Accordingly, the analysis system may apply the proposed rule to the set of structured data. The analysis system may further transmit, to the administrator device, an indication of an outcome of applying the proposed rule to the set of structured data.

### BACKGROUND

Data lakes may store large amounts of unstructured and/or structured data. For example, data lakes may include log files, user information, transaction information, and/or event logs, among other examples.

### SUMMARY

Some implementations described herein relate to a system for enforcing data quality with machine learning. The system may include one or more memories and one or more processors communicatively coupled to the one or more memories. The one or more processors may be configured to receive, from at least one data source, a set of structured data. The one or more processors may be configured to provide the set of structured data to a machine learning model to receive an indication of a proposed rule. The one or more processors may be configured to transmit, to an administrator device, a prompt indicating the proposed rule. The one or more processors may be configured to receive, from the administrator device and in response to the prompt, an acceptance of the proposed rule. The one or more processors may be configured to apply the proposed rule to the set of structured data. The one or more processors may be configured to transmit, to a ticket system, a command to open at least one ticket associated with an outcome of applying the proposed rule to the set of structured data.

Some implementations described herein relate to a method of enforcing data quality with machine learning. The method may include receiving, at an analysis system and from at least one data source, a set of structured data. The method may include providing, by the analysis system, the set of structured data to a machine learning model to receive an indication of a proposed rule. The method may include transmitting, from the analysis system and to an administrator device, a prompt indicating the proposed rule. The method may include receiving, at the analysis system and from the administrator device, an acceptance of the proposed rule in response to the prompt. The method may include applying, by the analysis system, the proposed rule to the set of structured data. The method may include transmitting, from the analysis system and to the administrator device, an indication of an outcome of applying the proposed rule to the set of structured data.

Some implementations described herein relate to a non-transitory computer-readable medium that stores a set of instructions for enforcing data quality with machine learning. The set of instructions, when executed by one or more processors of a device, may cause the device to transmit a command to assess a set of structured data. The set of instructions, when executed by one or more processors of the device, may cause the device to receive, in response to the command, an indication of a proposed rule to apply to the set of structured data, wherein the proposed rule is from a machine learning model. The set of instructions, when executed by one or more processors of the device, may cause the device to transmit, based on input from a user of the device, an acceptance of the proposed rule. The set of instructions, when executed by one or more processors of the device, may cause the device to receive, in response to the acceptance, an indication of an outcome of applying the proposed rule to the set of structured data.

### BRIEF DESCRIPTION OF THE DRAWINGS

FIGS. 1A-ID are diagrams of an example implementation relating to using machine learning to determine data quality rules, in accordance with some embodiments of the present disclosure.

FIG. 2 is a diagram illustrating an example of training and using a machine learning model in connection with determining data quality rules, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to using machine learning to determine data quality rules, in accordance with some embodiments of the present disclosure.

FIG. 6 is a flowchart of an example process relating to receiving data quality rules based on machine learning, in accordance with some embodiments of the present disclosure.

### DETAILED DESCRIPTION

The following detailed description of example implementations refers to the accompanying drawings. The same reference numbers in different drawings may identify the same or similar elements.

Data lakes may store large amounts of unstructured data (e.g., in text files) and/or structured data (e.g., in extensible markup language (XML) files and/or comma-separated values (CSV) files, among other examples). Because storage costs have plummeted, more data than ever is being stored, leading to an exponential increase in memory overhead (that is, memory space consumed by data). Accordingly, many organizations store vast amounts of log files, user information, transaction information, and event logs, among other information, in data lakes.

Memory overhead may be reduced by pruning data lakes. In order to automate data pruning, machine learning may be deployed to measure data quality. For example, a machine learning model may modify files to improve data quality and/or mark files that fail to satisfy a quality threshold for deletion. However, machine learning applied directly to a data lake functions essentially as a black box. Accordingly, the machine learning model may perform erroneous modifications and/or incorrectly mark files for deletion. After a problem is detected, identifying the machine learning model as the cause and undoing the erroneous modifications and/or incorrect markings for deletion may consume a significant amount of power and/or processing resources.

Some implementations described herein enable a machine learning model to suggest data quality rules for a set of data rather than modifying the set of data directly. Therefore, an administrator may review the data quality rules before deploying the rules on the set of data. As a result, erroneous modifications and/or incorrect markings for deletion are reduced or even eliminated, which conserves power and processing resources that otherwise would have been spent on undoing the erroneous modifications and/or incorrect markings. Additionally, some implementations described herein enable automatic creation of tickets (e.g., in an issue tracking system) in response to the suggested data quality rules. As a result, power and processing resources are conserved that otherwise would have been consumed in processing output from the machine learning model and creating the tickets based on the output.

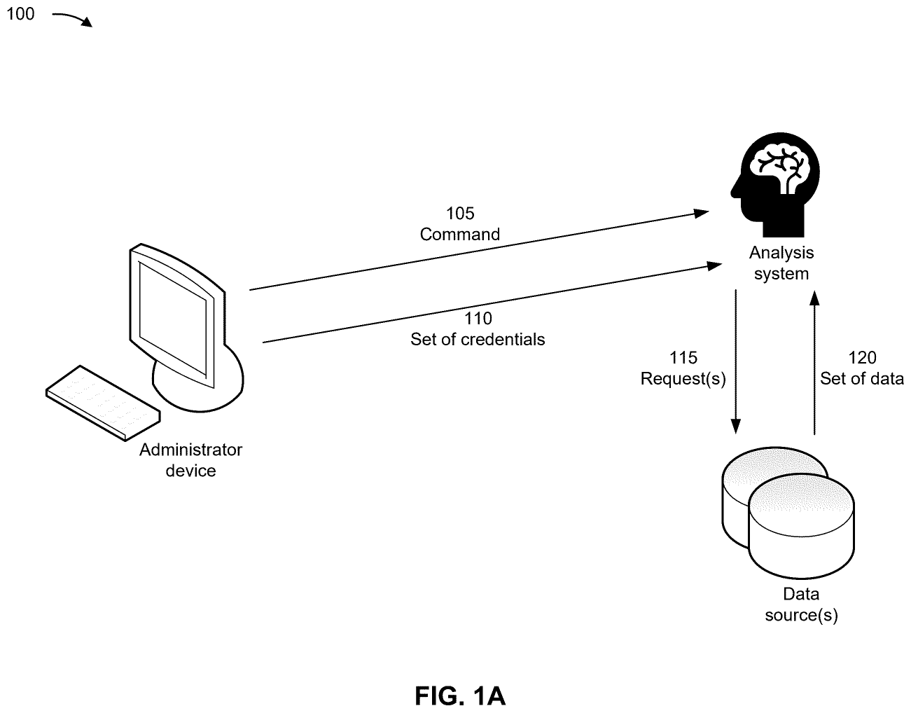

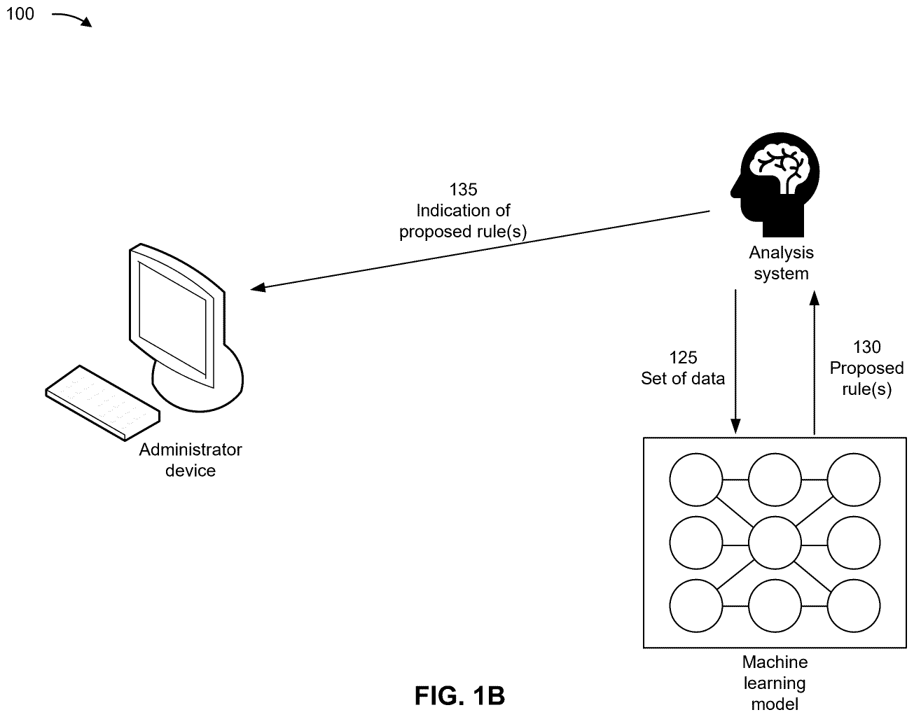

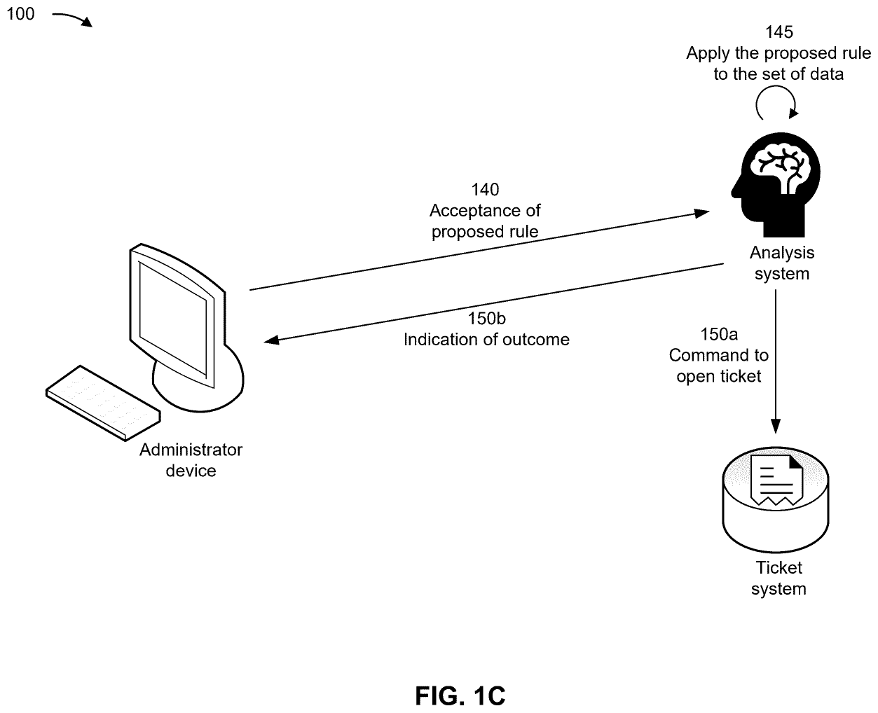

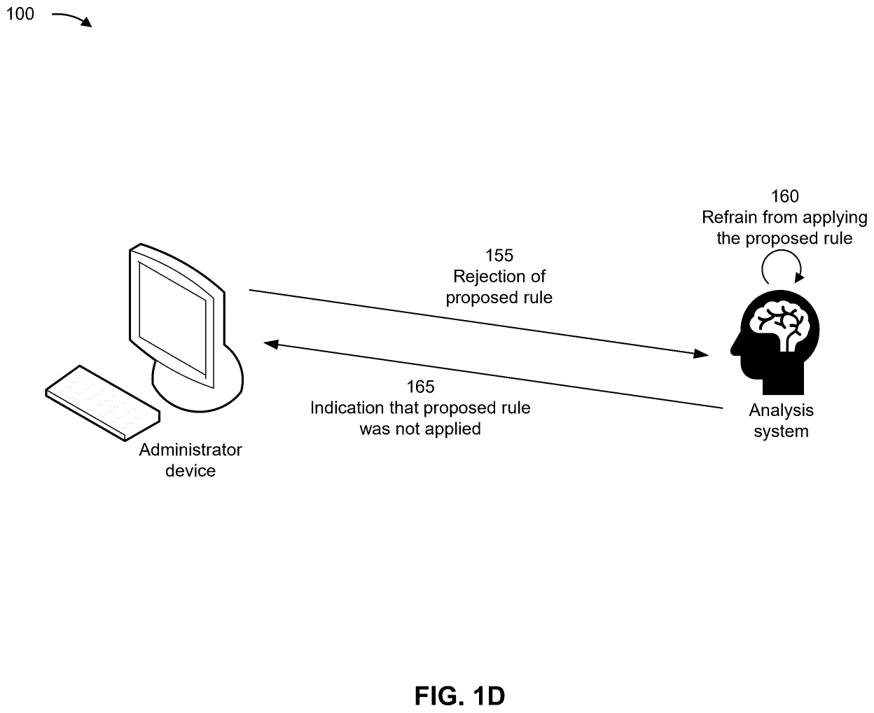

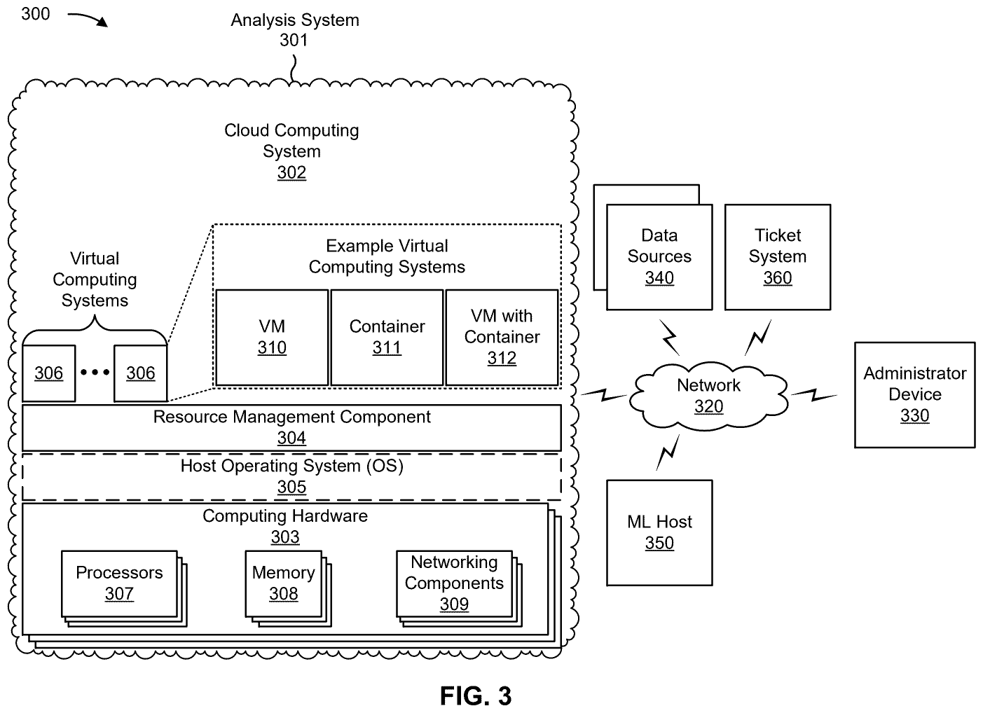

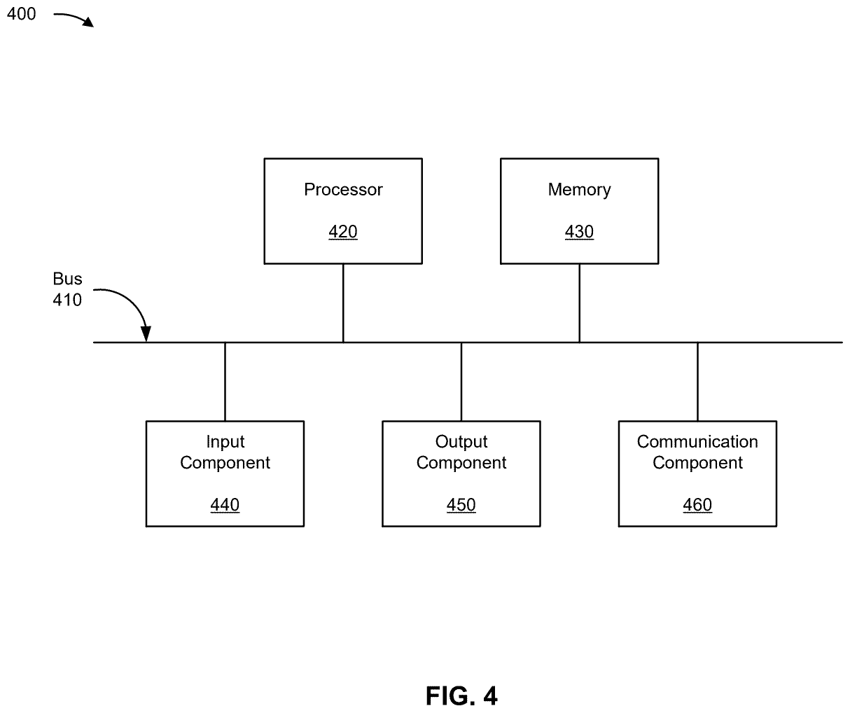

FIGS. 1A-1D are diagrams of an example 100 associated with using machine learning to determine data quality rules. As shown in FIGS. 1A-1D, example 100 includes an analysis system, an administrator device, one or more data sources, a machine learning (ML) model (e.g., provided by an ML host), and a ticket system. These devices are described in more detail in connection with FIGS. 3 and 4.

As shown in FIG. 1A and by reference number 105, the administrator device may transmit, and the analysis system may receive, a command to assess a set of data. The command may include a hypertext transfer protocol (HTTP) request and/or an application programming interface (API) call. In one example, a user of the administrator device may provide input (e.g., via an input component of the administrator device), using a command line, a bash shell, or another type of text interface, that triggers the administrator device to transmit the command. Alternatively, the administrator device may output a user interface (UI), and the user may provide the input, that triggers the administrator device to transmit the command, by interacting with the UI (e.g., via an input component of the administrator device). For example, the administrator device may execute a web browser, and the user may provide the input by interacting with a UI of the web browser.

The command may indicate the set of data (e.g., in a header and/or as an argument). For example, the command may indicate a location associated with the set of data. The location may include a filename, a file path, an alphanumeric identifier associated with the set of data, and/or another type of identifier that indicates where the set of data is stored. Additionally, or alternatively, the location may include an Internet protocol (IP) address, a medium access control (MAC) address, and/or another type of identifier of the data source(s) that store the set of data.

As shown by reference number 110, the administrator device may transmit, and the analysis system may receive, a set of credentials. The set of credentials may be associated with the data source(s) that store the set of data. The set of credentials may include a username and password, a passcode, a secret answer, a certificate, a private key, and/or biometric information, among other examples. The set of credentials may allow the analysis system to access the set of data from the data source(s), as described in connection with reference numbers 115 and 120.

In some implementations, the administrator device may transmit the command and the set of credentials in a same message. Alternatively, the administrator device may transmit the command in a different message than the set of credentials. For example, the analysis system may transmit, and the administrator device may receive, a request for credentials in response to the command. Accordingly, the administrator device may transmit the set of credentials in response to the request from the analysis system.

As shown by reference number 115, the analysis system may transmit, and the data source(s) may receive, a request (e.g., one or more requests) for the set of data. The request may include an HTTP request, a file transfer protocol (FTP) request, and/or an API call. The request may indicate the set of data (e.g., in a header and/or as an argument). For example, the request may include a filename, a file path, a name of at least one dataset, and/or another type of identifier associated with the set of data.

In some implementations, the request may further include the set of credentials. For example, the set of credentials may allow the data source(s) to authenticate the request and provide the set of data to the analysis system. In some implementations, the analysis system may transmit the request and the set of credentials in a same message. Alternatively, the analysis system may transmit the request in a different message than the set of credentials. For example, the data source(s) may transmit, and the analysis system may receive, a request for credentials in response to the request for the set of data. Accordingly, the analysis system may transmit the set of credentials in response to the request from the data source(s).

In examples where the set of data is stored across a plurality of data sources, the analysis system may transmit a plurality of requests, and each may be associated with a different data source. Therefore, each request may include a corresponding credential, in the set of credentials, for the data source that corresponds to the request.

As shown by reference number 120, the data source(s) may transmit, and the analysis system may receive, the set of data. The data source(s) may transmit the set of data in response to the request from the analysis system. In examples where the set of data is stored across a plurality of data sources, the analysis system may receive a plurality of responses from the plurality of data sources and may extract the set of data from the plurality of responses.

Although the example 100 is described in connection with the analysis system requesting the set of data in response to the command from the administrator device, other examples may include the analysis system automatically requesting the set of data. For example, the analysis system may transmit the request for the set of data periodically (e.g., according to a schedule, whether a default schedule or a schedule configured by the administrator device). In another example, the analysis system may transmit the request for the set of data in response to a command, from an external device, that is not triggered by a user.

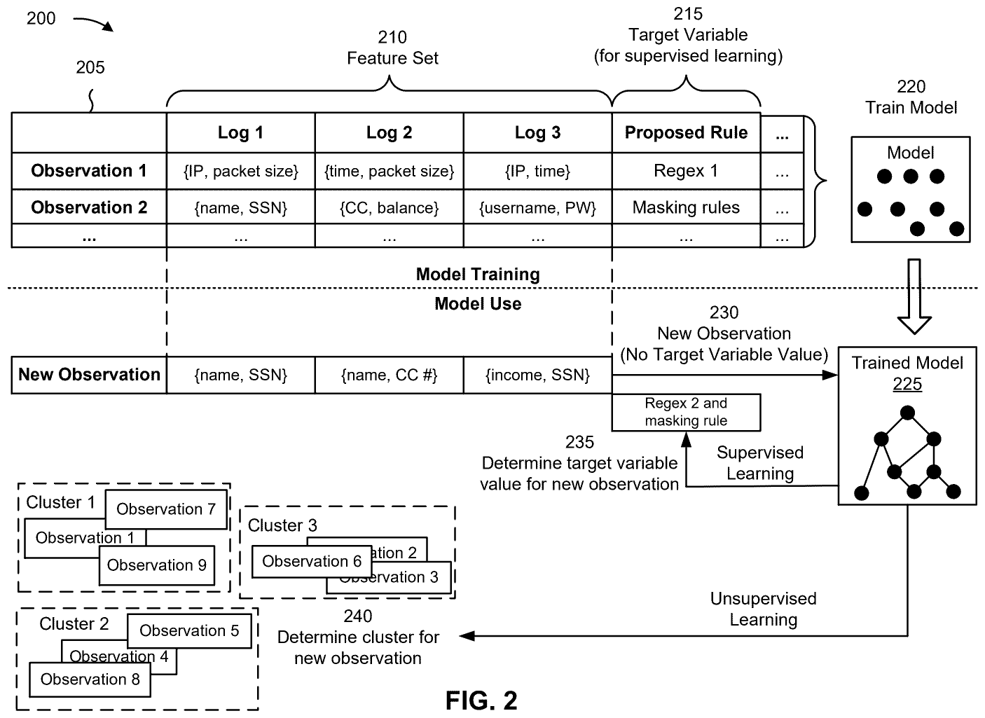

As shown in FIG. 1B and by reference number 125, the analysis system may provide the set of data to the ML model. For example, the analysis system may transmit, and the ML host may receive, a request including the set of data. The ML model may be as described in connection with FIG. 2. The ML model may be trained (e.g., by the ML host and/or a device at least partially separate from the ML host) using a labeled set of data (e.g., for supervised learning). Additionally, or alternatively, the ML model may be trained using an unlabeled set of data (e.g., for deep learning).

The ML model may suggest data quality rules to apply to the set of data. For example, a data quality rule may suggest a modification to the set of data (e.g., combining data to reduce redundancies, among other examples). Additionally, or alternatively, a data quality rule may suggest a method for marking portions of the set of data for deletion (e.g., scoring portions of the set of data, such that scores that fail to satisfy a quality threshold result in marks for deletion).

The ML model is disallowed from modifying the set of data. In other words, the ML model may suggest data quality rules but may not modify the set of data or mark portions of the set of data for deletion. The ML model therefore is not a black box that is applied to the set of data. As a result, erroneous modifications and/or incorrect markings for deletion are reduced or even eliminated, which conserves power and processing resources that otherwise would have been spent on undoing the erroneous modifications and/or incorrect markings.

As shown by reference number 130, the analysis system may receive an indication of one or more proposed rules from the ML model. The proposed rule(s) may include a regular expression (also referred to as a “regex”). Additionally, or alternatively, the proposed rule(s) may include a quality threshold that would result in portions of the set of data being marked for deletion.

As shown by reference number 135, the analysis system may transmit, and the administrator device may receive, an indication of the proposed rule(s). The administrator device may receive the indication of the proposed rule(s) in response to the command from the administrator device (e.g., as described in connection with reference number 105). The indication may be included in an HTTP response and/or as a return to an API call from the administrator device.

In some implementations, the analysis system may transmit a prompt indicating the proposed rule(s). Accordingly, the administrator device may output the prompt, for review by the user, using a command line, a bash shell, or another type of text interface. Additionally, or alternatively, the analysis system may transmit instructions for a UI that indicates the proposed rule(s). Accordingly, the administrator device may output the UI to the user.

As shown in FIG. 1C and by reference number 140, the administrator device may transmit, and the analysis system may receive, an acceptance of the proposed rule. The administrator device may transmit the acceptance based on input from the user of the administrator device, and the analysis system may receive the acceptance in response to the prompt from the analysis system.

In some implementations, the user of the administrator device may provide input (e.g., via an input component of the administrator device), using a command line, a bash shell, or another type of text interface, that triggers the administrator device to transmit the acceptance. For example, the text interface may include the prompt from the analysis system, and the user may provide the input in response to the prompt. Alternatively, the user may provide the input, that triggers the administrator device to transmit the acceptance, by interacting with a confirmation element in a UI (e.g., via an input component of the administrator device). For example, the UI my include the prompt from the analysis system, and the administrator device may transmit to the analysis system an indication, of the interaction with the confirmation element, as the acceptance of the proposed rule.

As shown by reference number 145, the analysis system may apply the proposed rule to the set of data. In some implementations, the analysis system may mark a portion of the set of data for deletion based on a compliance indicator output by the ML model. For example, the portion marked for deletion may fail to satisfy a quality threshold. Additionally, or alternatively, the analysis system may apply a regex that combines (or otherwise modifies) the set of data. For example, the analysis system may modify portions of the set of data to reduce redundancies and/or otherwise compress the set of data. Additionally, or alternatively, the analysis system may mask (or otherwise filter) the set of data. For example, the analysis system may filter portions of the set of data in order to improve security (e.g., complying with laws, regulations, and/or best practices for data security).

The user of the administrator device thus reviews the proposed rule before the analysis system applies the proposed rules on the set of data. As a result, erroneous modifications and/or incorrect markings for deletion are reduced or even eliminated, which conserves power and processing resources that otherwise would have been spent on undoing the erroneous modifications and/or incorrect markings.

In some implementations, as shown by reference number 150a, the analysis system may transmit, and the ticket system may receive, a command to open a ticket (e.g., at least one ticket). The ticket may be associated with an outcome of applying the proposed rule to the set of data. For example, the outcome may include a compliance indicator from the ML model, as described above. In another example, the outcome may include an indication, of a portion of the set of data, that was marked for deletion and/or filtered, as described above.

In some implementations, the analysis system may indicate a corresponding administrator (associated with the set of data) in the command such that the ticket tags the corresponding administrator. For example, the analysis system may determine, using a data structure mapping (i.e., that maps) dataset identifiers to user identifiers, the corresponding administrator associated with the set of data. For example, the analysis system may map a string representing the set of data (e.g., at least one title) to a string representing the corresponding administrator (e.g., a name of the administrator, a username, and/or an email address, among other examples).

In some implementations, the analysis system may include an email address, associated with the corresponding user, in the command. Accordingly, the ticket system may transmit email messages, associated with the ticket, to the email address. The email address may be indicated in the data structure. Alternatively, the analysis system may determine the email address from a database storing a contact list or another similar type of data structure. The database may be implemented in a local storage (e.g., a memory managed by the multimedia host) or in a storage that is at least partially separate (e.g., physically, logically, and/or virtually) from the multimedia host. Therefore, the analysis system may transmit a query to the database (e.g., included in an HTTP request and/or using an API call) and receive a response to the query (e.g., included in an HTTP response and/or as a return from the API call) that includes the email address.

Although the example 100 is described in connection with the ticket being associated with the outcome of applying the proposed rule to the set of data, other examples may include the ticket being associated with the proposed rule before acceptance from the administrator device. For example, the analysis system may transmit a command to open a ticket, associated with the proposed rule, in addition to, or in lieu of, transmitting the prompt to the administrator device. Accordingly, the administrator device may transmit the acceptance (or a rejection, as described below) in response to the ticket.

Additionally, or alternatively, as shown by reference number 150b, the analysis system may transmit, and the administrator device may receive, an indication of an outcome of applying the proposed rule to the set of data. For example, the analysis system may transmit the indication in an email message to an email address associated with the administrator device.

FIG. 1C shows operations associated with acceptance of the proposed rule, while FIG. 1D shows operations associated with rejection of the proposed rule. For example, as shown by reference number 155, the administrator device may transmit, and the analysis system may receive, a rejection of the proposed rule. The administrator device may transmit the rejection based on input from the user of the administrator device, and the analysis system may receive the rejection in response to the prompt from the analysis system.

In some implementations, the user of the administrator device may provide input (e.g., via an input component of the administrator device), using a command line, a bash shell, or another type of text interface, that triggers the administrator device to transmit the rejection. For example, the text interface may include the prompt from the analysis system, and the user may provide the input in response to the prompt. Alternatively, the user may provide the input, that triggers the administrator device to transmit the rejection, by interacting with a confirmation element in a UI (e.g., via an input component of the administrator device). For example, the UI may include the prompt from the analysis system, and the administrator device may transmit to the analysis system an indication, of the interaction with the confirmation element, as the rejection of the proposed rule.

As shown by reference number 160, the analysis system may refrain from applying the proposed rule to the set of data. In some implementations, the analysis system may discard the proposed rule (e.g., from a local memory, such as a cache, controlled by the analysis system and/or from a storage that is at least partially separate from the analysis system).

As shown by reference number 165, the analysis system may transmit, and the administrator device may receive, an indication that the proposed rule was not applied to the set of data. In some implementations, the analysis system may transmit an indication that the proposed rule was discarded. In one example, the analysis system may transmit the indication in an email message to an email address associated with the administrator device.

By using techniques as described in connection with FIGS. 1A-1D, the ML model suggests the proposed rule for the set of data rather than modifying the set of data directly. Therefore, the user of the administrator device may review the proposed rule before the analysis system applies the proposed rule to the set of data. As a result, erroneous modifications and/or incorrect markings for deletion are reduced or even eliminated, which conserves power and processing resources that otherwise would have been spent on undoing the erroneous modifications and/or incorrect markings. Additionally, the analysis system may automatically open the ticket in the ticket system. As a result, power and processing resources are conserved that otherwise would have been consumed in processing output from the ML model and creating the ticket based on the output.

As indicated above, FIGS. 1A-1D are provided as an example. Other examples may differ from what is described with regard to FIGS. 1A-1D.

FIG. 2 is a diagram illustrating an example 200 of training and using a machine learning model in connection with determining data quality rules. The machine learning model training and usage described herein may be performed using a machine learning system. The machine learning system may include or may be included in a computing device, a server, a cloud computing environment, or the like, such as an analysis system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from one or more data sources and/or a ticket system, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the data source(s) and/or the ticket system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a first log file included in a set of data, a second feature of a second log file included in the set of data, a third feature of a third log file included in the set of data, and so on. As shown, for a first observation, the first feature may include variables with IP addresses and packet sizes, the second feature may include variables with time (e.g., timestamps) and packet sizes, the third feature may include variables with IP address and time (e.g., timestamps), and so on. These features and feature values are provided as examples, and may differ in other examples. For example, the feature set may include one or more of the following features: tables of user information, recorded transaction information, event logs, and/or other types of structured and/or unstructured data.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a proposed rule, which has a value of a first regex for the first observation.

The feature set and target variable described above are provided as examples, and other examples may differ from what is described above. For example, the target variable may include a compliance indicator that may be used to identify features (e.g., log files) to be marked for deletion.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. In other words, the machine learning model may compare a current feature set (e.g., a current set of data) to previous feature sets (e.g., previous sets of data) to identify proposed rules to apply to the current feature set. After training, the machine learning system may store the machine learning model as a trained machine learning model 225 to be used to analyze new observations.

As an example, the machine learning system may obtain training data for the set of observations based on labeled sets of data. For example, previous sets of data may be labeled with rules that were applied to those sets of data. Additionally, or alternatively, the machine learning system may obtain training data for the set of observations based on unlabeled sets of data. For example, the machine learning system may assess unlabeled sets of data to identify relevant features and propose rules for the sets of data based on the relevant features.

As shown by reference number 230, the machine learning system may apply the trained machine learning model 225 to a new observation, such as by receiving a new observation and inputting the new observation to the trained machine learning model 225. As shown, the new observation may include a first feature of a first log file (including variables with names and social security numbers (SSNs)), a second feature of a second log file (including variables with names and credit card numbers (CC #s)), a third feature of a third log file (including variables with incomes and SSNs), and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of a second regex and a masking rule for the target variable of a proposed rule for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation to apply the second regex and the masking rule. The first automated action may include, for example, outputting an indication of the second regex and the masking rule to an administrator device.

As another example, if the machine learning system were to predict a value of a quality threshold for the target variable of the proposed rule, then the machine learning system may provide a second (e.g., different) recommendation (e.g., a recommendation to delete any log files that fail to satisfy the quality threshold) and/or may perform or cause performance of a second (e.g., different) automated action (e.g., outputting an indication of the quality threshold to the administrator device).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., associated with data that satisfies a quality threshold), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., associated with data that fails to satisfy the quality threshold), then the machine learning system may provide a second (e.g., different) recommendation, such as the second recommendation described above, and/or may perform or cause performance of a second (e.g., different) automated action, such as the second automated action described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

The recommendations, actions, and clusters described above are provided as examples, and other examples may differ from what is described above. For example, the clusters may be associated with different regexes and/or filters, among other examples.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include acceptance or rejection of proposed rules (e.g., from the administrator device).

In this way, the machine learning system may apply a rigorous and automated process to proposing data quality rules. The machine learning system suggests rules rather than directly modifying (and/or deleting) data, thereby increasing accuracy and consistency and reducing computing resources to be allocated for undoing modifications (and/or deletions) performed by black box machine learning models.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include an analysis system 301, which may include one or more elements of and/or may execute within a cloud computing system 302. The cloud computing system 302 may include one or more elements 303-312, as described in more detail below. As further shown in FIG. 3, environment 300 may include a network 320, an administrator device 330, a set of data sources 340, an ML host 350, and/or a ticket system 360. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the analysis system 301 may include one or more elements 303-312 of the cloud computing system 302, may execute within the cloud computing system 302, and/or may be hosted within the cloud computing system 302, in some implementations, the analysis system 301 may not be cloud-based (e.g., may be implemented outside of a cloud computing system) or may be partially cloud-based. For example, the analysis system 301 may include one or more devices that are not part of the cloud computing system 302, such as device 400 of FIG. 4, which may include a standalone server or another type of computing device. The analysis system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The administrator device 330 may include one or more devices capable of receiving, generating, storing, processing, and/or providing information associated with data quality rules, as described elsewhere herein. The administrator device 330 may include a communication device and/or a computing device. For example, the administrator device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The administrator device 330 may communicate with one or more other devices of environment 300, as described elsewhere herein.

The set of data sources 340 may include one or more devices capable of receiving, generating, storing, processing, and/or providing information associated with structured (and/or unstructured) data, as described elsewhere herein. The set of data sources 340 may include a set of communication devices and/or computing devices. For example, the set of data sources 340 may include a database, a server, a database server, an application server, a client server, a web server, a host server, a proxy server, a virtual server (e.g., executing on computing hardware), a server in a cloud computing system, a device that includes computing hardware used in a cloud computing environment, and/or a similar type of device. The set of data sources 340 may communicate with one or more other devices of environment 300, as described elsewhere herein.

The ML host 350 may include one or more devices capable of receiving, generating, storing, processing, and/or providing information associated with machine learning models, as described elsewhere herein. The ML host 350 may include a communication device and/or a computing device. For example, the ML host 350 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 350 may communicate with one or more other devices of environment 300, as described elsewhere herein.

The ticket system 360 may include one or more devices capable of receiving, generating, storing, processing, and/or providing information associated with tickets, as described elsewhere herein. The ticket system 360 may include a communication device and/or a computing device. For example, the ticket system 360 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ticket system 360 may include an issue tracking system, such as Jira® or Bugzilla©, among other examples. The ticket system 360 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with using machine learning to determine data quality rules. The device 400 may correspond to an administrator device 330, a data source 340, an ML host 350, and/or a ticket system 360. In some implementations, an administrator device 330, a data source 340, an ML host 350, and/or a ticket system 360 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

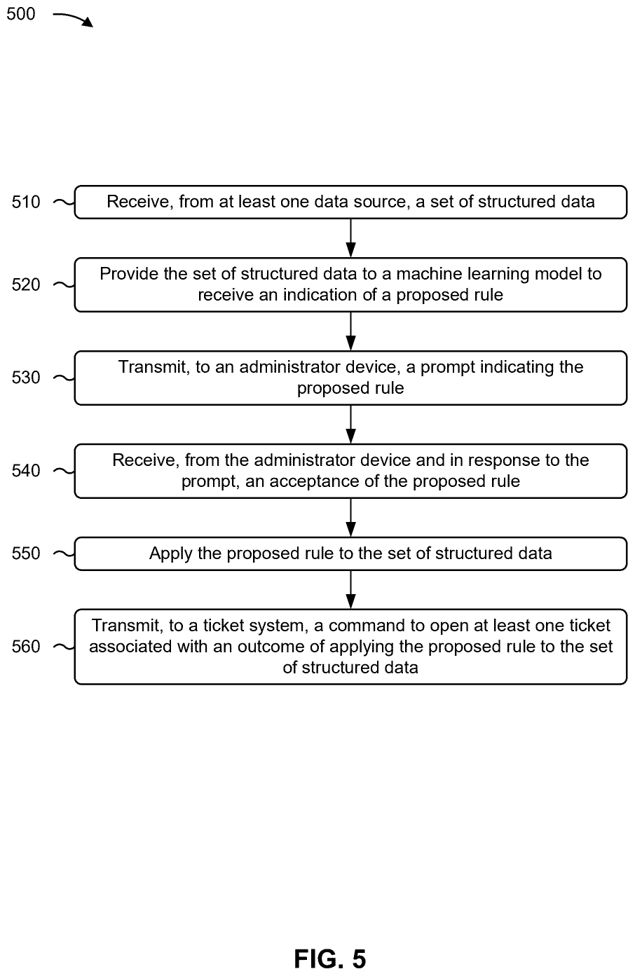

FIG. 5 is a flowchart of an example process 500 associated with using machine learning to determine data quality rules. In some implementations, one or more process blocks of FIG. 5 may be performed by an analysis system 301. In some implementations, one or more process blocks of FIG. 5 may be performed by another device or a group of devices separate from or including the analysis system 301, such as an administrator device 330, a data source 340, an ML host 350, and/or a ticket system 360. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from at least one data source, a set of structured data (block 510). For example, the analysis system 301 (e.g., using processor 420, memory 430, and/or communication component 460) may receive, from at least one data source, a set of structured data, as described above in connection with reference number 120 of FIG. 1A. As an example, the analysis system 301 may transmit, and the at least one data source may receive, at least one request for the set of structured data. Accordingly, the at least one data source may transmit, and the analysis system 301 may receive, the set of structured data in response to the at least one request from the analysis system 301.

As further shown in FIG. 5, process 500 may include providing the set of structured data to a machine learning model to receive an indication of a proposed rule (block 520). For example, the analysis system 301 (e.g., using processor 420, memory 430, and/or communication component 460) may provide the set of structured data to a machine learning model to receive an indication of a proposed rule, as described above in connection with reference numbers 125 and 130 of FIG. 1B. As an example, the analysis system 301 may transmit, and an ML host may receive, a request including the set of structured data. Accordingly, the ML host may transmit, and the analysis system 301 may receive, an indication of the proposed rule.

As further shown in FIG. 5, process 500 may include transmitting, to an administrator device, a prompt indicating the proposed rule (block 530). For example, the analysis system 301 (e.g., using processor 420, memory 430, and/or communication component 460) may transmit, to an administrator device, a prompt indicating the proposed rule, as described above in connection with reference number 135 of FIG. 1B. As an example, the prompt may be text-based (e.g., intended for a command line, a bash shell, or another type of text interface) and/or graphical (e.g., included in instructions for a UI).

As further shown in FIG. 5, process 500 may include receiving, from the administrator device and in response to the prompt, an acceptance of the proposed rule (block 540). For example, the analysis system 301 (e.g., using processor 420, memory 430, and/or communication component 460) may receive, from the administrator device and in response to the prompt, an acceptance of the proposed rule, as described above in connection with reference number 140 of FIG. 1C. As an example, the analysis system 301 may receive the acceptance in response to the prompt from the analysis system 301.

As further shown in FIG. 5, process 500 may include applying the proposed rule to the set of structured data (block 550). For example, the analysis system 301 (e.g., using processor 420 and/or memory 430) may apply the proposed rule to the set of structured data, as described above in connection with reference number 145 of FIG. 1C. As an example, the analysis system 301 may mark a portion of the set of structured data for deletion (e.g., based on a compliance indicator output by the ML model). Additionally, or alternatively, the analysis system 301 may apply a regex that combines (or otherwise modifies) the set of structured data (e.g., to reduce redundancies and/or otherwise compress the set of structured data). Additionally, or alternatively, the analysis system 301 may mask (or otherwise filter) the set of structured data (e.g., to improve security).

As further shown in FIG. 5, process 500 may include transmitting, to a ticket system, a command to open at least one ticket associated with an outcome of applying the proposed rule to the set of structured data (block 560). For example, the analysis system 301 (e.g., using processor 420, memory 430, and/or communication component 460) may transmit, to a ticket system, a command to open at least one ticket associated with an outcome of applying the proposed rule to the set of structured data, as described above in connection with reference number 150a of FIG. 1C. As an example, the outcome may include a compliance indicator from the machine learning model. In another example, the outcome may include an indication, of a portion of the set of structured data, that was marked for deletion and/or filtered.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D and/or FIG. 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

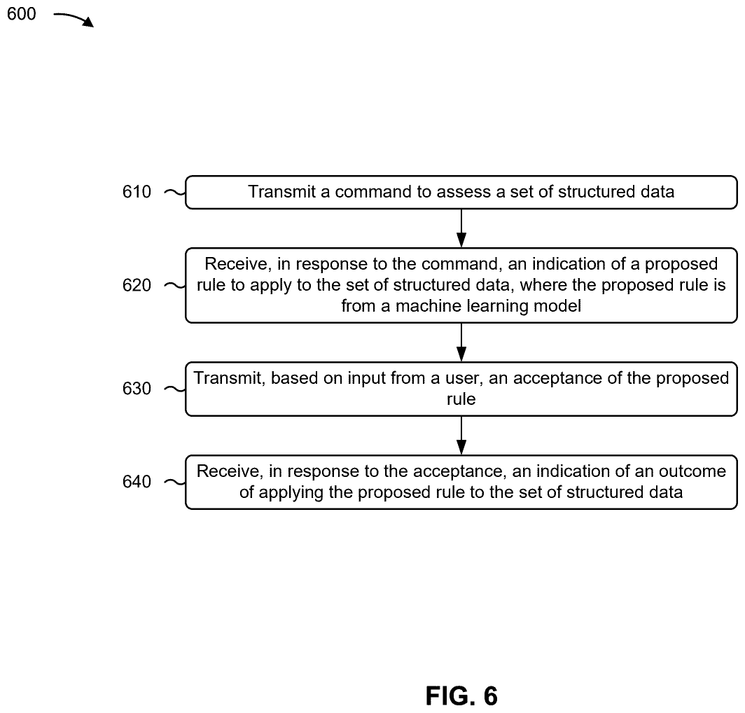

FIG. 6 is a flowchart of an example process 600 associated with receiving data quality rules based on machine learning. In some implementations, one or more process blocks of FIG. 6 may be performed by an administrator device 330. In some implementations, one or more process blocks of FIG. 6 may be performed by another device or a group of devices separate from or including the administrator device 330, such as an analysis system 301, a data source 340, an ML host 350, and/or a ticket system 360. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting a command to assess a set of structured data (block 610). For example, the administrator device 330 (e.g., using processor 420, memory 430, and/or communication component 460) may transmit a command to assess a set of structured data, as described above in connection with reference number 105 of FIG. 1A. As an example, a user of the administrator device 330 may provide input (e.g., via an input component 440), using a command line, a bash shell, or another type of text interface, that triggers the administrator device 330 to transmit the command. Alternatively, the administrator device 330 may output a UI, and the user may provide the input, that triggers the administrator device 330 to transmit the command, by interacting with the UI (e.g., via an input component 440).

As further shown in FIG. 6, process 600 may include receiving, in response to the command, an indication of a proposed rule to apply to the set of structured data, where the proposed rule is from a machine learning model (block 620). For example, the administrator device 330 (e.g., using processor 420, memory 430, and/or communication component 460) may receive, in response to the command, an indication of a proposed rule to apply to the set of structured data, where the proposed rule is from a machine learning model, as described above in connection with reference number 135 of FIG. 1B. As an example, the administrator device 330 may receive a prompt indicating the proposed rule. Accordingly, the administrator device 330 may output the prompt (e.g., via an output component 450), for review by the user, using a command line, a bash shell, or another type of text interface. Additionally, or alternatively, the administrator device 330 may receive instructions for a UI that indicates the proposed rule. Accordingly, the administrator device 330 may output the UI (e.g., via an output component 450) to the user.

As further shown in FIG. 6, process 600 may include transmitting, based on input from a user, an acceptance of the proposed rule (block 630). For example, the administrator device 330 (e.g., using processor 420, memory 430, and/or communication component 460) may transmit, based on input from a user, an acceptance of the proposed rule, as described above in connection with reference number 140 of FIG. 1C. As an example, the user may provide input (e.g., via an input component 440), using a command line, a bash shell, or another type of text interface, that triggers the administrator device 330 to transmit the acceptance. Alternatively, the user may provide the input, that triggers the administrator device 330 to transmit the acceptance, by interacting with a confirmation element in a UI (e.g., via an input component 440).

As further shown in FIG. 6, process 600 may include receiving, in response to the acceptance, an indication of an outcome of applying the proposed rule to the set of structured data (block 640). For example, the administrator device 330 (e.g., using processor 420, memory 430, input component 440, and/or communication component 460) may receive, in response to the acceptance, an indication of an outcome of applying the proposed rule to the set of structured data, as described above in connection with reference number 150b of FIG. 1C. As an example, the outcome may include a compliance indicator (e.g., from the machine learning model). In another example, the outcome may include an indication, of a portion of the set of structured data, that was marked for deletion and/or filtered.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1D and/or FIG. 2. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for enforcing data quality with machine learning, the system comprising:
one or more memories; and
one or more processors, communicatively coupled to the one or more memories, configured to:
receive, from at least one data source, a set of structured data;
provide the set of structured data to a machine learning model to receive an indication of a proposed rule;
transmit, to an administrator device, a prompt indicating the proposed rule;
receive, from the administrator device and in response to the prompt, an acceptance of the proposed rule;
apply the proposed rule to the set of structured data; and
transmit, to a ticket system, a command to open at least one ticket associated with an outcome of applying the proposed rule to the set of structured data.

2. The system of claim 1, wherein the proposed rule comprises at least one regular expression.

3. The system of claim 1, wherein the one or more processors, to transmit the prompt, are configured to:
transmit instructions for a user interface (UI) that indicates the proposed rule.

4. The system of claim 3, wherein the one or more processors, to receive the acceptance, are configured to:
receive an indication of an interaction with a confirmation element in the UI,
wherein the acceptance comprises the indication of the interaction.

5. The system of claim 1, wherein the one or more processors, to apply the proposed rule, are configured to:
determine a compliance indicator associated with the set of structured data,
wherein the outcome comprises the compliance indicator.

6. The system of claim 1, wherein the one or more processors, to apply the proposed rule, are configured to:
filter out a portion of the set of structured data,
wherein the outcome comprises an indication of the portion of the set of structured data.

7. The system of claim 1, wherein the machine learning model is disallowed from modifying the set of structured data.

8. A method of enforcing data quality with machine learning, comprising:
receiving, at an analysis system and from at least one data source, a set of structured data;
providing, by the analysis system, the set of structured data to a machine learning model to receive an indication of a proposed rule;
transmitting, from the analysis system and to an administrator device, a prompt indicating the proposed rule;
receiving, at the analysis system and from the administrator device, an acceptance of the proposed rule in response to the prompt;
applying, by the analysis system, the proposed rule to the set of structured data; and
transmitting, from the analysis system and to the administrator device, an indication of an outcome of applying the proposed rule to the set of structured data.

9. The method of claim Error! Reference source not found., further comprising:
transmitting, to the at least one data source, at least one request for the set of structured data,
wherein the set of structured data is received in response to the at least one request.

10. The method of claim 9, further comprising:
receiving, at the analysis system, a set of credentials associated with the at least one data source,
wherein the at least one request includes the set of credentials.

11. The method of claim Error! Reference source not found., wherein transmitting the indication of the outcome of applying the proposed rule comprises:
transmitting an email message including the indication of the outcome.

12. The method of claim Error! Reference source not found., wherein providing the set of structured data to the machine learning model comprises:
transmitting, to a machine learning host, the set of structured data; and
receiving, from the machine learning host and in response to transmitting the set of structured data, the indication of the proposed rule.

13. The method of claim Error! Reference source not found., wherein the machine learning model is disallowed from modifying the set of structured data.

14. A non-transitory computer-readable medium storing a set of instructions for enforcing data quality with machine learning, the set of instructions comprising:
one or more instructions that, when executed by one or more processors of a device, cause the device to:
transmit a command to assess a set of structured data;
receive, in response to the command, an indication of a proposed rule to apply to the set of structured data, wherein the proposed rule is from a machine learning model;
transmit, based on input from a user of the device, an acceptance of the proposed rule; and
receive, in response to the acceptance, an indication of an outcome of applying the proposed rule to the set of structured data.

15. The non-transitory computer-readable medium of claim Error! Reference source not found., wherein the one or more instructions, when executed by the one or more processors, cause the device to:
transmit a set of credentials associated with at least one data source that stores the set of structured data.

16. The non-transitory computer-readable medium of claim Error! Reference source not found., wherein the one or more instructions, that cause the device to receive the indication of the outcome, cause the device to:
receive a compliance indicator associated with the set of structured data.

17. The non-transitory computer-readable medium of claim Error! Reference source not found., wherein the one or more instructions, that cause the device to receive the indication of the outcome, cause the device to:
receive an indication of a portion, of the set of structured data, that was filtered out.

18. The non-transitory computer-readable medium of claim Error! Reference source not found., wherein the one or more instructions, that cause the device to receive the indication of the proposed rule, cause the device to:
receive instructions for a user interface (UI) that indicates the proposed rule.

19. The non-transitory computer-readable medium of claim 18, wherein the one or more instructions, that cause the device to transmit the acceptance, cause the device to:
transmit an indication of an interaction with a confirmation element in the UI,
wherein the acceptance comprises the indication of the interaction.

20. The non-transitory computer-readable medium of claim Error! Reference source not found., wherein the one or more instructions, when executed by the one or more processors, cause the device to:
receive an indication of an additional proposed rule to apply to the set of structured data;
transmit, based on additional input from the user of the device, a rejection of the additional proposed rule; and
receive, in response to the rejection, an indication that the additional proposed rule was discarded.
